(19) United States
(12) Patent Application Publication
(10) Pub. No.: US 2004/0247653 A1
(43) Pub. Date: Dec. 9, 2004

(54) Antimicrobial and antiviral polymeric materials and a process for preparing the same

(75) Inventor: Jeffrey Gabbay, Jerusalem (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Cupron Corporation, New York City, NY

(21) Appl. No.: 10/890,936

(22) Filed: Jul. 14, 2004

Related U.S. Application Data
(63) Continuation-in-part of application No. 10/240,993, filed on Dec. 16, 2002.
Application No. 10/240,993 is a 371 of international application No. PCT/IL01/00299, filed on Apr. 1, 2001.

(30) Foreign Application Priority Data
Apr. 5, 2000 (IL) 135,487

(51) Int. Cl. A61K 33/34; A61K 9/70

(52) U.S. Cl. 424/443; 424/635; 442/123

(57) ABSTRACT

The invention provides an antimicrobial and antiviral polymeric material formed from a polymeric component selected from the group consisting of a polyamide, a polyester, an acrylic and a polyalkylene, and mixtures thereof, said material being in the form of a fiber or a yarn and comprising a single antimicrobial and antiviral agent consisting essentially of microscopic water insoluble particles of ionic copper oxides in powder form, embedded directly in said component, with a portion of said particles being exposed and protruding from surfaces thereof, which particles release Cu⁺⁺.

The present specification is a continuation-in-part of U.S. Ser. No. 10/240993 with a filing date of Apr. 1, 2001

The present invention relates to an antimicrobial and antiviral polymeric material and to a process for preparing the same. More particularly, the present invention relates to an antimicrobial polymeric material useful as a wrapping material for agricultural produce. The invention also relates to an antimicrobial and antiviral polymeric material useful for the formation of a backing material for carpets and the formation of molded products such as air filters for hospitals or airplanes and masks which can be either air or liquid permeable as well as for many other applications as discussed hereinafter.

A problem faced by all food exporters is the attack on the agricultural produce after it has been harvested by microorganisms while in transport. This is especially true when the transportation is measured in days, weeks, or months, rather than hours. Microorganisms are known to cause severe damage to the produce, resulting in added costs which are passed on to the consumer. An example of this is the strawberry harvest in Israel. Every year about 50% of the harvest is lost while in transportation due to the attack of microorganisms. To date, there has been no effective system developed that can effectively reduce the waste rate.

There are many wrapping materials used in food transport from burlap bags to sophisticated polymer wrappings that demonstrate qualities such as strength, flexibility, breathability and are inexpensive. However, none to date are able to control the growth of microorganisms that flourish in packaged, agricultural produce.

According to the present invention it has now been discovered that by adding a small percentage of Cu++ in the form of water insoluble copper oxide particles to the slurry of a polymer to be formed into a wrapping material, the package is rendered antimicrobial.

Furthermore it has been surprisingly discovered that by adding copper oxide in particle form into a polymeric slurry of such polymers as polyethylene, polypropylene, polyesters and similar hydrophobic polymeric materials it is possible to extrude fibers, yarns or sheets which possess both antimicrobial and antiviral properties which have a multiplicity of uses. Among the uses contemplated for the novel antimicrobial and antiviral polymeric materials of the present invention is their use in a backing for a carpet, which could even be used in a hospital setting since it would not develop mold, smell, and would inactivate any viruses settling thereon; the use as a component of a molded non-woven product such as an air filter in a hospital or airplane or a mask which could be made air permeable or liquid permeable and be used to filter fluids flowing therethrough and to inactivate bacteria and viruses found in said fluids; formation into a continuous, flat, textured or stretched form which could be used in articles of clothing such as stockings, socks, shirts or any article of clothing that would incorporate a hydrophobic polymeric fiber or yarn; formation of a short staple fiber which could be then used as is or blended with other fibers such as cotton, which blended yarns could then be used for the manufacture of a variety of both knit and woven products such as socks, sheets, etc.; and use of such polymeric materials, manufactured in the form of a bi-component yarn in which the core is one compound and the sheath around the core is a polymer containing the water insoluble copper oxide particles creating a yarn with a multitude of end uses in either a continuous, flat, textured, stretched form or as a short staple. An example of said latter use would be the use of a polyethylene core with a polymeric sheath incorporating said water insoluble copper oxide particles to form a yarn with an increased resistance to being cut or ripped while also being both antimicrobial and antiviral and having a multiplicity of uses including in the food preparation industry.

In both WO 98/06508 and WO 98/06509 there are taught various aspects of a textile with a full or partial metal or metal oxide plating directly and securely bonded to the fibers thereof, wherein metal and metal oxides, including copper, are bonded to said fibers.

More specifically, in WO 98/06509 there is provided a process comprising the steps of: (a) providing a metallized textile, the metallized textile comprising: (i) a textile including fibers selected from the group consisting of natural fibers, synthetic cellulosic fibers, regenerated fibers, acrylic fibers, polyolefin fibers, polyurethane fibers, vinyl fibers, and blends thereof, and (ii) a plating including materials selected from the group consisting of metals and metal oxides, the metallized textile characterized in that the plating is bonded directly to the fibers; and (b) incorporating the metallized textile in an article of manufacture.

In the context of said invention the term “textile” includes fibers, whether natural (for example, cotton, silk, wool, and linen) or synthetic yarns spun from those fibers, and woven, knit, and non-woven fabrics made of those yarns. The scope of said invention includes all natural fibers; and all synthetic fibers used in textile applications, including but not limited to synthetic cellulosic fibers (i.e., regenerated cellulose fibers such as rayon, and cellulose derivative fibers such as acetate fibers), regenerated protein fibers, acrylic fibers, polyolefin fibers, polyurethane fibers, and vinyl fibers, but excluding nylon and polyester fibers, and blends thereof.

Said invention comprised application to the products of an adaptation of boards made of plastic, with metals. See, for example, Encyclopedia of Polymer Science and Engineering (Jacqueline I. Kroschwitz, editor), Wiley and Sons, 1987, vol. IX, pp 580-598. As applied to textiles, this process included two steps. The first step was the activation of the textile by precipitating catalytic noble metal nucleation sites on the textile. This was done by first soaking the textile in a solution of a low-oxidation-state reductant cation, and then soaking the textile in a solution of noble metal cations, preferably a solution of Pd++ cations, most preferably an acidic PdCl₂ solution. The low-oxidation-state cation reduces the noble metal cations to the noble metals themselves, while being oxidized to a higher oxidation state. Preferably, the reductant cation is one that is soluble in both the initial low oxidation state and the final high oxidation state, for example Sn++, which is oxidized to Sn++++, or Ti+++, which is oxidized to Ti++++.

The second step was the reduction, in close proximity to the activated textile, of a metal cation whose reduction was catalyzed by a noble metal. The reducing agents used to reduce the cations typically were molecular species, for example, formaldehyde in the case of Cu++. Because the reducing agents were oxidized, the metal cations are termed “oxidant cations” herein. The metallized textiles thus produced were characterized in that their metal plating was bonded directly to the textile fibers.

In WO 98/06508 there is described and claimed a composition of matter comprising:

(a) a textile including fibers selected from the group consisting of natural fibers, synthetic cellulosic fibers, regenerated protein fibers, acrylic fibers, polyolefin fibers, polyurethane fibers, vinyl fibers, and blends thereof; and

(b) a plating including materials selected from the group consisting of metals and metal oxides;

the composition of matter characterized in that said plating is bonded directly to said fibers.

Said publication also claims a composition of matter comprising:

(a) a textile including fibers selected from the group consisting of natural fibers, synthetic cellulosic fibers, regenerated protein fibers, acrylic fibers, polyolefin fibers, polyurethane fibers, vinyl fibers, and blends thereof; and

(b) a plurality of nucleation sites, each of said nucleation sites including at least one noble metal;

the composition of matter characterized by catalyzing the reduction of at least one metallic cationic species to a reduced metal, thereby plating said fibers with said reduced metal.

In addition, said publication teaches and claims processes for producing said products.

A preferred process for preparing a metallized textile according to said publication comprises the steps of:

a) selecting a textile, in a form selected from the group consisting of yarn and fabric, said textile including fibers selected from the group consisting of natural fibers, synthetic cellulosic fibers, regenerated protein fibers, acrylic fibers, polyolefin fibers, polyurethane fibers, vinyl fibers, and blends thereof;

b) soaking said textile in a solution containing at least one reductant cationic species having at least two positive oxidation states, said at least one cationic species being in a lower of said at least two positive oxidation states;

c) soaking said textile in a solution containing at least one noble metal cationic species, thereby producing an activated textile; and

d) reducing at least one oxidant cationic species in a medium in contact with said activated textile, thereby producing a metallized textile.

Said publications, however, are limited to coated fibers and textiles prepared according to said processes and do not teach or suggest the possibility of incorporating cationic copper into a polymeric slurry of a hydrophobic polymer whereby there are produced films and fibers having microscopic particles of cationic copper encapsulated therein and protruding therefrom and having antimicrobial and antiviral polymeric properties, as described and exemplified herein.

With this state of the art in mind there is now provided according to the present invention an antimicrobial and antiviral polymeric material formed from a polymeric component selected from the group consisting of a polyamide, a polyester, an acrylic and a polyalkylene, said material being in the form of a fiber, a yarn, or a sheet, and comprising a single antimicrobial and antiviral agent consisting essentially of microscopic water insoluble particles of cationic copper oxides in powder form, embedded directly in said component, with a portion of said particles being exposed and protruding from surfaces thereof, which particles release Cu⁺⁺.

In another aspect of the present invention there is provided a process for preparing an antimicrobial and antiviral polymeric material, comprising preparing an antimicrobial and antiviral polymeric material as defined above, comprising preparing a slurry of a polymer selected from the group consisting of a polyamide, a polyester, an acrylic and a polyalkylene, and mixtures thereof, introducing a powder consisting essentially of water insoluble cationic copper oxides and dispersing the same in said slurry and then extruding said slurry to form a polymeric material wherein water insoluble copper oxide particles that release Cu⁺⁺ are encapsulated therein with a portion of said particles being exposed and protruding from surfaces thereof.

The polymeric material of the present invention can be in the form of a film, a fiber, or a yarn, wherein said films can be used per se, e.g. for wrapping or can be cut into fine strips, woven into a substrate to form a backing for a carpet by punching said substrate with carpet pile and said fibers and yarns can be formed into a packaging material for agricultural products or into a non-woven molded product, such as a non-woven mask, an air filter for a hospital or airplane, or a gauze. Similarly the polymeric materials of the present invention can be mixed with other fibers or materials and used to prepare feminine hygiene products, diapers, shoe-lining material, etc.

Similarly as stated hereinbefore said polymer can be in a continuous, flat, textured or stretched form which can be used in articles of clothing, etc.

Said material can be made from almost any synthetic polymer, which will allow the introduction of an cationic, copper oxide particles into its liquid slurry state. Examples of some materials are polyamides (nylon), polyester, acrylic, and polyalkylenes such as polyethylene and polypropylene. When the copper oxide dust is ground down to fine powder, e.g., a size of between 1 and 10 microns and introduced into the slurry in small quantities, e. g., in an amount of between 0.25 and 10% of the polymer weight, it was found that the subsequent product produced from this slurry exhibited both antimicrobial and antiviral properties.

In especially preferred embodiments of the present invention said polyalkylene is polypropylene.

As described hereinbefore in a further preferred embodiment of the present invention said polymeric material is manufactured in the form of a short staple fiber and the present invention is also directed to a blended yarn incorporating such fibers.

In yet another preferred embodiment of the present invention there is provided a bi-component yarn wherein at least one of the components is an antimicrobial and antiviral polymeric material as herein defined.

The present invention also provides an article of clothing incorporating a yarn which includes an antimicrobial and antiviral polymeric material as herein defined.

Another aspect of the present invention relates to the use of water insoluble copper oxide particles which release Cu⁺⁺ for the preparation of a polymeric material having microscopic water insoluble copper oxide particles which release Cu⁺⁺ encapsulated therein with a portion of said particles being exposed and protruding from surfaces thereof for inhibition of HIV-1 proliferation.

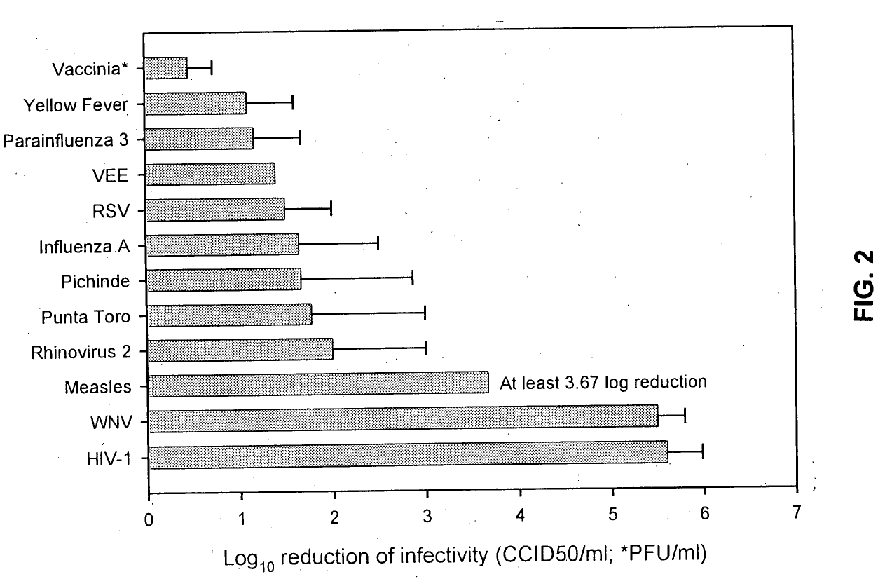

The present invention also relates to the use of water insoluble copper oxide particles which release Cu⁺⁺ for the preparation of a polymeric material having microscopic water insoluble copper oxide particles which release Cu⁺⁺ encapsulated therein with a portion of said particles being exposed and protruding from surfaces thereof for neutralizing infectious viruses as illustrated with reference to FIG. 2 hereinafter.

Unlike the fibers described, e. g. in WO 98/06508 and WO 98/06509, in which the fibers are coated on the outside, in the present product the polymer has microscopic water insoluble particles of cationic copper oxide encapsulated therein with a portion of said particles being exposed and protruding from surfaces thereof. These exposed particles which protrude from the surface of the polymeric material have been shown to be active, as demonstrated by the tests set forth hereinafter.

In general, the products of the present invention are produced as follows:

1. A slurry is prepared from any polymer, the chief raw material preferably being selected from a polyamide, a polyalkylene, a polyurethane and a polyester. Combinations of more than one of said materials can also be used provided they are compatible or adjusted for compatibility. The polymeric raw materials are usually in bead form and can be mono-component, bi-component or multi-component in nature. The beads are heated to melting at a temperature which preferably will range from about 120 to 180° C.

2. At the hot mixing stage, before extrusion, a water insoluble powder of cationic copper oxide is added to the slurry and allowed to spread through the heated slurry. The particulate size will be preferably between 1 and 10 microns, however can be larger when the film or fiber thickness can accommodate larger particles.

3. The liquid slurry is then pushed with pressure through holes in a series of metal plates formed into a circle called a spinneret. As the slurry is pushed through the fine holes that are close together, they form single fibers or if allowed to contact one another, they form a film or sheath. The hot liquid fiber or film is pushed upward with cold air forming a continuous series of fibers or a circular sheet. The thickness of the fibers or sheet is controlled by the size of the holes and speed at which the slurry is pushed through the holes and upward by the cooling air flow.

4. In percentage mixtures of up to 10% by weight of cationic copper oxide dust demonstrated, no degradation of physical properties in a polyamide slurry of the finished product. When tested, mixtures as low as 1% still showed antimicrobial properties, as well as surprisingly showing inhibition of HIV-1 activity.

In WO 94/15463 there are described antimicrobial compositions comprising an inorganic particle with a first coating providing antimicrobial properties and a second coating providing a protective function wherein said first coating can be silver or copper or compounds of silver, copper and zinc and preferred are compounds containing silver and copper (II) oxide. Said patent, however, is based on the complicated and expensive process involving the coating of the metallic compositions with a secondary protective coating selected from silica, silicates, borosilicates, aluminosilicates, alumina, aluminum phosphate, or mixtures thereof and in fact all the claims are directed to compositions having successive coatings including silica, hydrous alumina and dioctyl azelate.

In contradistinction, the present invention is directed to the use and preparation of a polymeric material, having microscopic water insoluble particles of cationic copper oxide in powder form, which release Cu⁺⁺ encapsulated therein with a portion of said particles being exposed and protruding from surfaces thereof, which is neither taught nor suggested by said publication and which has the advantage that the exposed Cu⁺⁺ releasing water insoluble particles which protrude from the polymeric material have been proven to be effective even in the inhibition of HIV-1 activity.

In EP 427858 there is described an antibacterial composition characterized in that inorganic fine particles are coated with an antibacterial metal and/or antibacterial metal compound and said patent does not teach or suggest a polymer that incorporates microscopic water insoluble particles of cationic copper oxide in powder form, which release Cu⁺⁺ encapsulated therein with a portion of said particles being exposed and protruding from surfaces thereof.

In DE 4403016 there is described a bacteriacidal and fungicidal composition utilizing copper as opposed to ionic Cu⁺⁺ and said patent also does not teach or suggest a polymer that incorporates microscopic water insoluble particles of cationic copper oxide in powder form, which release Cu⁺⁺ encapsulated therein with a portion of said particles being exposed and protruding from surfaces thereof.

In JP-01 046465 there is described a condom releasing sterilizing ions utilizing metals selected from copper, silver, mercury and their alloys which metals have a sterilizing and sperm killing effect, wherein the metal is preferably finely powdered copper. While copper salts such as copper chloride, copper sulfate and copper nitrate are also mentioned, as is known, these are water soluble salts which will dissolve and break down the polymer in which they are introduced. Similarly, while cuprous oxide is specifically mentioned, this is a Cu⁺ ionic form, and therefore said patent does not teach or suggest the use of exposed Cu⁺⁺ releasing water insoluble particles which protrude from the polymeric material and which have been proven to be effective even in the inhibition of HIV-1 activity.

In JP-01 246204 there is described an antimicrobial molded article in which a mixture of a powdery copper compound and organic polysiloxane are dispersed into a thermoplastic molded article for the preparation of cloth, socks, etc. Said patent specifically states and teaches that metal ions cannot be introduced by themselves into a polymer molecule and requires the inclusion of organopolysiloxane which is also intended to provide a connecting path for the release of copper ions to the fiber surface. Thus, as will be realized said copper compound will be encapsulated and said patent does not teach or suggest the use of exposed Cu⁺⁺ releasing water insoluble copper oxide particles that protrude from the polymeric material.

In JP-03 113011 there is described a fiber having good antifungus and hygienic action preferably for producing underwear wherein said synthetic fiber contains copper or a copper compound in combination with germanium or a compound thereof, however, said patent teaches and requires the presence of a major portion of germanium and the copper compounds disclose therein are preferably metallic copper, cuprous iodide which is a monovalent Cu⁺ compound and water soluble copper salts. Thus, said patent does not teach or suggest the use of exposed Cu⁺⁺ releasing water insoluble copper oxide particles which protrude from the polymeric material.

In EP 116865 there is described and claimed a polymer article containing zeolite particles at least part of which retain at least one metal ion having a bacterial property and thus said patent does not teach or suggest the use of exposed Cu⁺⁺ releasing water insoluble copper oxide particles, by themselves and in the absence of a zeolite, which particles protrude from the polymeric material and which have been proven to be effective even in the inhibition of HIV-1 activity.

In EP 253653 there is described and claimed a polymer containing amorphous aluminosilicate particles comprising an organic polymer and amorphous aluminosilicate solid particles or amorphous aluminosilicate solid particles treated with a coating agent, at least some of said amorphous aluminosilicate solid particles holding metal ions having a bactericidal actions. Thus, said patent does not teach or suggest the use of exposed Cu⁺⁺ releasing water insoluble copper oxide particles, by themselves and in the absence of amorphous aluminosilicate particles, which exposed Cu⁺⁺ releasing water insoluble copper oxide particles, protrude from the polymeric material and which have been proven to be effective even in the inhibition of HIV-1 activity.

Referring to the use of the material as a post harvest packaging system, it was found that microbes outside the package will not be able to enter the enclosed area and that microbes inside the packet will have difficulty in growing along the inside of the packaging material which is usually where they incubate due to condensation within the encapsulated area.

While the invention will now be described in connection with certain preferred embodiments in the following examples and with reference to the attached figures, so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

In the drawings:

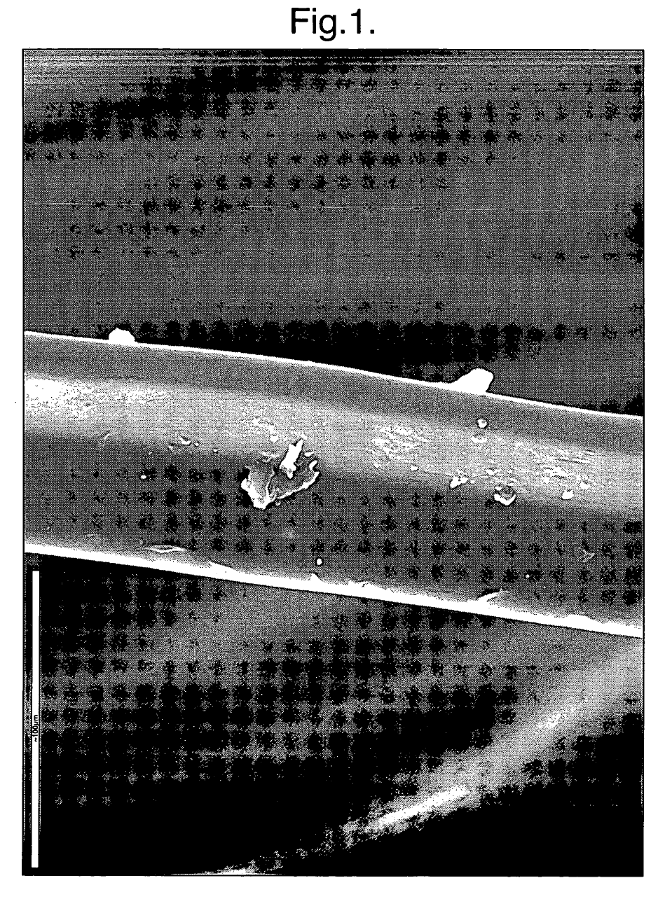

FIG. 1 is an electron microscope photograph of a nylon fiber with copper particles embedded therein and protruding therefrom after having been added to a polymeric slurry; and

FIG. 2 is a graphical representation of reduction of viral titer following filtration of various viruses in medium through polyester fabric filters produced according to the present invention.

### EXAMPLE 1

### Preparation of Fibers

A total of 500 grams of a polyamide bi-component compound were prepared by heating the two beaded chemicals in separate baths each at 160° C.

The two separate components were then mixed together and allowed to stir for 15 minutes until the mixture appeared to be homogenous in color.

The mixed chemistry was again divided into two separate pots. In one pot, 25 grams of a mixture of CuO and Cu₂O powder was added yielding a 1% mixture. In the second pot 6.25 grams of a mixture of CuO and Cu₂O were added yielding a 0.25% mixture. In both cases, the temperature of 160° C. was maintained. The compounds were stirred until they appeared homogenous in color.

The two mixtures were run through a spinneret with holes that yielded fibers of between 50 and 70 microns in diameter. Since the Cu⁺⁺ releasing copper oxide powders were ground to particles of less than 20 microns no obstructions in the spinneret holes were observed. The extruded fibers were air-cooled and spun on to cones.

The fibers were tested for biological activity.

The difference between the normal process of manufacturing any synthetic fiber and this process is the addition of the Cu⁺⁺ releasing copper oxide powders in the raw materials.

### EXAMPLE 2

100 μl aliquots of highly concentrated HIV-1 virus were incubated on top of the fibers produced according to example 1 for 30 minutes at 37° C. Then 10 μl of each pretreated virus were added to MT-2 cells (Lymphocyte Human Cell Line) cultured in 1 ml media. The cells were then incubated for 5 days in a moist incubator at 37° C. and the virus infectivity and proliferation was determined by measuring the amount of p24 (a specific HIV-1 protein) in the supernatant with a commercial ELISA (Enzyme Based Immuno-absorbtion Assay) kit. The results are the average of duplicate experiments. As control for possible cytotoxicity of the CuO or Cu₂O to the cells, similar experiments were carried out as above, but the fibers were incubated with 100 μl of natural medium that did not contain HIV-1. No cytotoxicity was observed, i.e., none of the host cells were observed to be killed, under the experimental conditions described above.

The following summarizes the evaluation of the capacity of the several fibers impregnated with CuO and Cu₂O to inhibit HIV-1 proliferation in tissue culture:

| | |
|---|---|
| Negative control (Polymeric Fiber without CuO and | no inhibition |
| Cu₂O): | |
| Positive control (CuO and Cu₂O powder): | 70% inhibition |
| 1% CuO and Cu₂O Fiber: | 26% inhibition. |

### EXAMPLE 3

### Antifungal Susceptibility Testing

Susceptibility testing was performed as follows:

Agar formulation used for this test was chosen in accordance with NCCLS document M27-A: RPMI (RPG) and a buffered to pH 7.0 with 0.165 M morpholinepropanesulfonic acid buffer (MOPS).

For the test, 90-mm-diameter plates containing agar at a depth of 4.0 mm were used. For Candida albicans, Cryptococcus neoformans, micrococcus, Tinea pedis, and Tinea curpus, the inoculum was prepared from a 24 hour culture and a 48 hour culture respectively; whereas for Aspergillus fumigatus and Trichophyton mentagrophytes a five-day old culture was used. Cell suspension was prepared in sterile 0.85% NaCl adjusted to a turbidity of a 0.5 McFarland standard. The agar surface was inoculated by streaking a nontoxic swab dipped in a cell suspension across the entire surface of the agar in three directions.

After excess moisture was absorbed into the agar and the surface was completely dry, Fibers treated according to example 1, in a concentration range from 3%-10% were applied to each plate. The plates were incubated at 35° C. and read after 24 hours, 48 hours, and 7 days. Antifungal activity of the treated fibers was considered positive if a zone of inhibition was visible underneath and surrounding the fibers.

### Antibacterial Susceptibility Testing

Susceptibility testing was performed as described above for the antifungal activity with the following modifications: Mueller-Hinton agar (Difco, Detroit, Mich.) was the medium used. The pH was adjusted to 7.2-7.4. The bacteria used for this study were Escherichia coli, Staphylococcus aureus, brevubacterium, acinetobacter and micrococcus.

### Results

The treated fibers in a concentration range of 3-10% exhibited characteristic inhibitory zone underneath and surrounding the fibers, indicating correct antifungal and antibacterial activity. The controls (untreated fibers) indicated no antifungal or antibacterial activity.

### EXAMPLE 4

### Anti Viral Testing

Polyester yarn, into which a cationic species of copper oxide was introduced with a portion of said particles being exposed and protruding from surfaces thereof, was prepared. The yarn was knit to form a fabric which fabric was cut into circular pieces and 20 such circular pieces of polyester fabric having water insoluble copper oxide particles incorporated therein were fitted into filters. The capacity of the filters to decrease viral infectious titers in filterable solutions was tested. As control, filters containing 20 circular pieces of polyester fabric that was not impregnated with copper were used.

### Methods

Filter treatment Clarified viral stocks were diluted 1:20 in culture medium without serum. Ten milliliters of each viral lysate were passed through control or copper-treated filters by applying moderate pressure to a syringe plunger. The filtrate was collected in sterile tubes and the surviving virus assayed as described below. An unfiltered sample from each original clarified lysate was also titered in parallel. The following viruses were tested: Influenza A/Panama/2007/99, Venezuelan equine encephalitis (VEE) virus (Trinidad strain), Vaccinia virus (WR strain), Yellow fever virus (17D strain), Pichinde virus (PCV) strain AN 4763, Punta Toro virus (PTV) strain Adames, Rhinovirus 2 (strain HGP), Human Immunodeficiency Virus Type-1 (HIV-1), West Nile Virus (WNV), Respiratory Syncytial Virus (RSV) strain A2, Measles (MV) stain Chicago, and Parainfluenza virus type 3 (HPIV-3) strain 14702.

Virus Titration Assay: The reduction of infectivity of the filtered viruses was determined basically by the end-point dilution, as described in. Reed, L. J. and Muench, M. 1938. A simple method of estimating fifty percent end points. Am. J. Hyg. 27:493-498. and. Louder, M. K., Mascola, J. R. (1999) Determination of syncytium-inducing phenotype of primary HIV-1 isolates using MT-2 cells. In HIV Protocols (Michael, N. and Kim, J. H., eds) pp. 23-27, Humana Press Inc, Totowa.

Briefly, immediately after filtration, sequential 10 fold dilutions of the filtrate were done in the appropriate culture medium in six separate rows of wells in a 96 well plate. Subsequently, the appropriate target cells in culture medium pre-positioned in six separate wells in a 96 well plate were exposed to each dilution of the virus. Thus, for each viral dilution six replicate wells were used. After 6 days of culture at 37° C., viral infectivity was determined by microscopic assessment. For example, MT-2 infection by T-tropic HIV-1 isolates results in syncytia formation. Each well in which even one syncytia was observed, was considered as a positive well, i.e. infected with HIV-1. The infectivity of the vaccinia virus, which forms plaques, was similarly determined, by quantifying the plaque forming units. The reduction in the infectious viral titers for each virus was determined by comparing the titer of the viruses with the unfiltered virus sample.

### Results

The reduction of the infectious titers of all the viruses filtered through the filters containing yarn into which a cationic species of copper oxide was introduced with a portion of said particles being exposed and protruding from surfaces thereof is summarized in FIG. 2. The control filters (filters containing polyester yarn that was not treated with copper) did not reduce significantly the infectious titers of the different virus tested (not shown).

As will be noted from the table in FIG. 2 under all circumstances a minimum of a 50-70% reduction of infectivity was noted all the way to a 99.999% reduction in the infectivity of HIV-1 and West Nile Virus which are of critical importance today.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1. An antimicrobial and antiviral polymeric material formed from a polymeric component selected from the group consisting of a polyamide, a polyester, an acrylic and a polyalkylene, and mixtures thereof, said material being in the form of a fiber, a yarn, or a sheet and comprising a single antimicrobial and antiviral agent consisting essentially of microscopic water insoluble particles of ionic copper oxides in powder form, embedded directly in said component, with a portion of said particles being exposed and protruding from surfaces thereof, which particles release Cu⁺⁺.

2. An antimicrobial and antiviral polymeric material according to claim 1, wherein the ionic copper comprises a mixture of CuO and Cu₂O.

3. An antimicrobial and antiviral polymeric material according to claim 1, wherein said particles are of a size of between 1 and 10 microns.

4. An antimicrobial and antiviral polymeric material according to claim 1, wherein said particles are present in an amount of between 0.25 and 10% of the polymer weight.

5. An antimicrobial and antiviral polymeric material according to claim 1, wherein said polyalkylene is polypropylene.

6. An antimicrobial and antiviral polymeric material according to claim 1, wherein said polymeric component is a single polymeric component.

7. An antimicrobial and antiviral polymeric material according to claim 1, wherein said polymeric material is manufactured in the form of a short staple fiber.

8. A blended yarn incorporating fibers according to claim 7.

9. A bi-component yarn wherein at least one of the components is an antimicrobial and antiviral polymeric material according to claim 1.

10. An article of clothing incorporating a yarn which includes an antimicrobial and antiviral polymeric material according to claim 1.

11. A wrapping material comprising an antimicrobial polymeric material according to claim 1.

12. A carpet having an antimicrobial and antiviral polymeric material according to claim 1 incorporated into a backing layer thereof.

13. A non-woven molded product having an antimicrobial and antiviral polymeric material according to claim 1 incorporated therein.

14. A non-woven molded product according to claim 13, wherein said product is air permeable.

15. A non-woven molded product according to claim 13, wherein said product is liquid permeable.

16. A process for preparing an antimicrobial and antiviral polymeric material as claimed in claim 1, comprising preparing a slurry of a polymer selected from the group consisting of a polyamide, a polyester, an acrylic and a polyalkylene and mixtures thereof, introducing a powder consisting essentially of water insoluble cationic copper oxides and dispersing the same in said slurry and then extruding said slurry to form a polymeric material wherein water insoluble particles that release Cu⁺⁺ are encapsulated therein with a portion of said particles being exposed and protruding from surfaces thereof.

17. A process according to claim 16, wherein said polymeric material is formed into a fiber, a yarn, or a sheet.

18. (canceled)

19. (canceled)
